(19) United States
(12) Patent Application Publication
(10) Pub. No.: US 2026/0164360 A1
(43) Pub. Date: Jun. 11, 2026

(54) POWER SAVING METHOD AND RELATED APPARATUS

(71) Applicant: Morelink Technology Corporation, Taipei City (TW)

(72) Inventor: Yung-ting LEE, Taipei City (TW)

(21) Appl. No.: 18/930,121

(22) Filed: Oct. 29, 2024

(51) Int. Cl. H04W 52/02; H04B 17/318; H04W 52/36

(52) U.S. Cl. CPC H04W 52/0274; H04B 17/318; H04W 52/367

(57) ABSTRACT

Provided is a power saving method and related apparatus. In the power saving method, performed by a repeater, downlink transmission in a given frequency band is turned off when UL mute continues for a predetermined time period. This can reduce power consumption of the repeater to a great extent since the DL transmission is turned off in addition to the UL mute. In another aspect, the DL transmission in a given band is turned off due to a large difference between DL power strength for the frequency band and an averaged DL power strength for other frequency bands to reduce power consumption of the repeater.

### TECHNICAL FIELD

The present application relates to wireless communication technologies, and more particularly to a power saving method and related apparatus.

### BACKGROUND

In wireless communication systems, signals are exchanged between a base station (e.g., a cell tower, or gNB in 5G NR (New Radio)) and one or more mobile terminals or user equipments (UEs). The base station can provide services within a coverage area, which may be expanded by a use of repeaters. The repeaters can improve the quality of wireless communication by receiving, filtering, amplifying and re-transmitting the signals communicated between the base station and the one or more UEs in both an uplink (UL) direction (i.e., from the UE to the base station) and a downlink (DL) direction (i.e., from the base station to the UE).

Intelligent or cognitive repeaters capable of sensing changes during operation and then adaptively adjusting operating parameters for power saving are barely seen in current market. However, there are some schemes that may be relevant to power saving of the repeater. One example is UL mute scheme, and another example is DL underpower shutdown scheme, as described below.

For the UL mute scheme, when UL RSSI (Received Signal Strength Indicator) continues to be lower than a pre-defined threshold for a pre-defined time period (e.g., several minutes), repeater UL transmission (Tx) will be turned off. In this case, repeater DL Rx operation is kept unchanged in this scheme. The UL mute scheme can reduce the power consumption of the repeater. However, the main purpose of UL mute scheme is to reduce the UL noise of the base station to avoid a reduced coverage of the base station and to prevent the base station from powering down or resetting or restarting. Without the UL mute scheme, it is possible that the base station may still be unable to operate normally after restarting.

For the DL underpower shutdown scheme, when DL RSSI continues to be lower than a pre-defined threshold for a pre-defined time period (e.g., several minutes), repeater DL Tx will be turned off. In this case, repeater UL Rx operation is kept unchanged in this scheme. The DL underpower shutdown scheme can reduce the power consumption of the repeater. However, the main purpose of DL underpower shutdown scheme is to prevent the repeater from transmitting low-quality radio frequency (RF) signals, avoiding noise signals from being propagated to the UE.

Although there are some traditional schemes (e.g., the UL mute scheme and the DL underpower shutdown scheme as described above) that can lead to a reduction of power consumption of the repeater, these schemes were not originally proposed or designed for power saving of the repeater. Therefore, there is a need to provide a power saving scheme for the repeater.

### SUMMARY

In a first aspect, the present application provides a power saving method by a repeater, which includes measuring received uplink (UL) power strength for a frequency band; determining whether the measured UL power strength of the frequency band is less than a first predetermined threshold for the frequency band for a first period of time; in response to the UL power strength of the frequency band less than the first predetermined threshold for the frequency band for the first period of time, performing UL mute to turn off UL transmission; determining whether the UL mute continues for a second period of time that is greater than a predetermined time period; and in response to the UL mute performed for the second period of time that is greater than the predetermined time period, turning off downlink (DL) transmission for the frequency band or maintaining DL output power at a predetermined minimum level for the frequency band.

In a second aspect, the present application provides a repeater, which includes a Rx circuit; a Tx circuit; and at least one processor, coupled to the Rx circuit and the Tx circuit, the at least one processor being configured to measure received uplink (UL) power strength for a frequency band; determine whether the measured UL power strength of the frequency band is less than a first predetermined threshold for the frequency band for a first period of time; in response to the UL power strength of the frequency band less than the first predetermined threshold for the frequency band for the first period of time, perform UL mute to turn off UL transmission; determine whether the UL mute continues for a second period of time that is greater than a predetermined time period; and in response to the UL mute performed for the second period of time that is greater than the predetermined time period, turn off downlink (DL) transmission for the frequency band or maintain DL output power at a predetermined minimum level for the frequency band.

In a third aspect, the present applicant provides a power saving method by a repeater, which includes measuring received downlink (DL) power strength for a frequency band; determining whether the measured DL power strength for the frequency band is greater than or less than an averaged DL power strength for other frequency bands by a first predetermined threshold; and in response to the DL power strength for the frequency band greater than or less than the averaged DL power strength for other frequency bands by the first predetermined threshold, turning off DL transmission for the frequency band or maintaining DL output power at a predetermined minimum level for the frequency band.

In a fourth aspect, the present applicant provides a repeater, which includes a Rx circuit; a Tx circuit; and at least one processor, coupled to the Rx circuit and the Tx circuit, the at least one processor being configured to measure received downlink (DL) power strength for a frequency band; determine whether the measured DL power strength for the frequency band is greater than or less than an averaged DL power strength for other frequency bands by a first predetermined threshold; and in response to the DL power strength for the frequency band greater than or less than the averaged DL power strength for other frequency bands by the first predetermined threshold, turn off DL transmission for the frequency band or maintain DL output power at a predetermined minimum level for the frequency band.

In embodiments of the present application, the DL transmission in a given frequency band is turned off when UL mute continues for the predetermined time period. This can reduce the power consumption of the repeater to a great extent since the DL transmission is also turned off in addition to UL mute. In other embodiments of the present application, the DL transmission in a given band is turned off due to a large difference between DL power strength for the frequency band and an averaged DL power strength for other frequency bands. This can reduce the power consumption of the repeater since the DL transmission is turned off.

### BRIEF DESCRIPTION OF THE DRAWINGS

FIG. 1 illustrates a possible network architecture to which the present application is applicable.

FIG. 2 is a block diagram illustrating a communication system according to some embodiments of the present application.

FIG. 3 is a block diagram illustrating an analog FDD repeater according to some embodiments of the present application.

FIG. 4 is a block diagram illustrating a digital FDD repeater according to some embodiments of the present application.

FIG. 5 is a flowchart of a power saving method according to a first embodiment of the present application.

FIG. 6 is a schematic diagram illustrating one-shot off to turn off DL transmission right away according to some embodiments of the present application.

FIG. 7 is a schematic diagram illustrating continuous off to gradually reduce DL output power until shutdown according to some embodiments of the present application.

FIG. 8 is a flow chart of a first example of power saving scheme according to some embodiments of the present application.

FIG. 9 is a flow chart of a second example of power saving scheme according to some embodiments of the present application.

FIG. 10 is a flowchart of a power saving method according to a second embodiment of the present application.

FIG. 11 is a flow chart of a third example of power saving scheme according to some embodiments of the present application.

FIG. 12 is a flow chart of a fourth example of power saving scheme according to some embodiments of the present application.

FIG. 13 is a flow chart of a fifth example of power saving scheme according to some embodiments of the present application.

### DETAILED DESCRIPTION

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

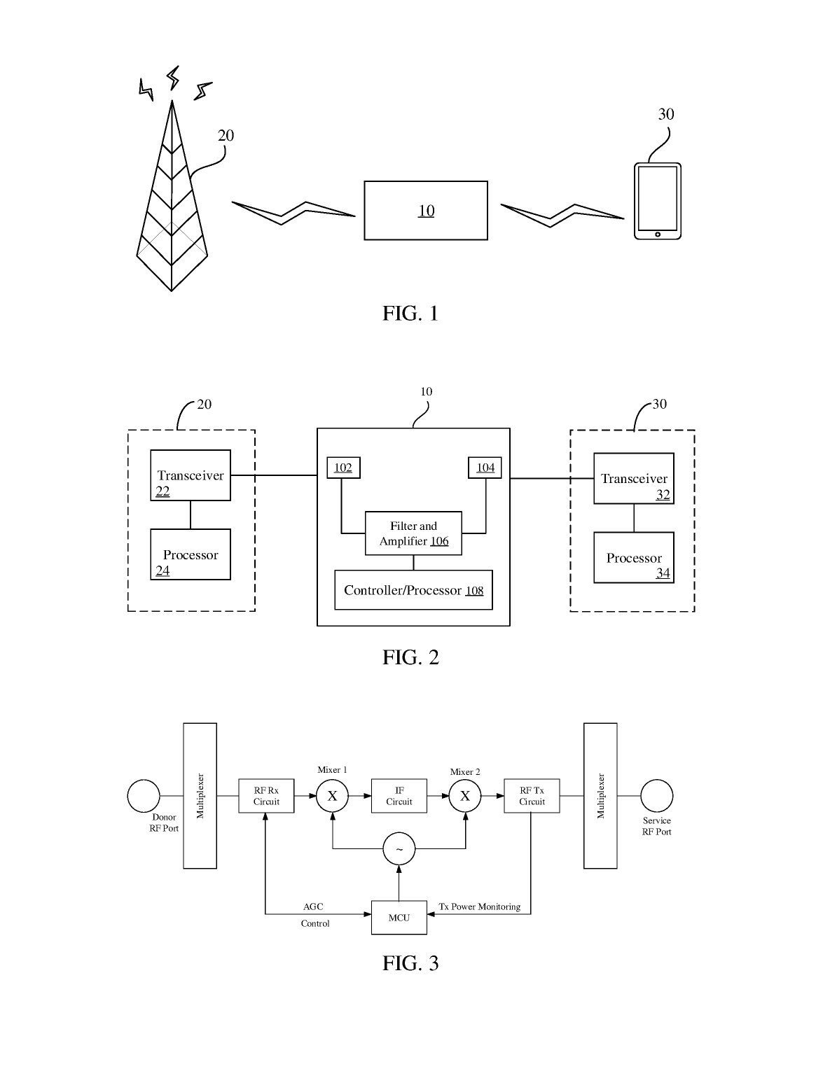

FIG. 1 illustrates a possible network architecture to which the present application is applicable. As shown in FIG. 1, a repeater 10 communicates with a base station (BS) 20 and a user equipment (UE) 30. The repeater 10 is used to repeat or forward signals received either from the base station 20 or the user equipment 30. The repeater can be a signal repeater or relay. The base station 20 is an entity used to transmit or receive signals on the network side, such as a base station in a wireless cellular network. The base station 20 can be, for example, an eNB (or eNodeB) in Long Term Evolution (LTE), or a gNB (or gNodeB) in New Radio (NR), or any network device in future mobile network. The user equipment 30 is a terminal device, which can exchange information and/or data with the wireless cellular network such as a radio access network (RAN). The user equipment 30 would be implemented by a wireless terminal, a user terminal, a terminal device, a mobile terminal (MT), and etc.

As shown in FIG. 1, the repeater 10 is arranged between the base station 20 and the user equipment 30. The repeater 10 can improve the quality of wireless communication by receiving, filtering, amplifying and re-transmitting the signals (more specifically, cellular communication signals) communicated between the base station 20 and the user equipment 30 in both an uplink direction (i.e., from the UE 30 to the base station 20) and a downlink direction (i.e., from the base station 20 to the UE 30). Although illustrated by only one user equipment and only one base station, the repeater 20 may serve more than one user equipments and may repeat signals from more than one base stations and transmit repeated signals to more than one base stations. The repeater 20 may be arranged at a fixed location, such as in a room of a building, or be mounted to a movable object, such as a vehicle.

FIG. 2 is a block diagram illustrating a communication system according to some embodiments of the present application. The communication system includes the afore-mentioned repeater 10, base station 20 and user equipment 30. Connections between devices and device components are shown as connecting lines in FIG. 2. The base station 20 includes a transceiver 22 and a processor 24, which are electrically connected with each other. The user equipment 30 includes a transceiver 32 and a processor 34, which are electrically connected with each other. The repeater 10 includes transceivers 102 and 104, a controller/processor 108, and a filter and amplifier 106 coupled between the transceivers 102 and 104 and the controller/processor 108. The transceiver 32 of the user equipment 30 is configured to transmit a signal, which is received by the repeater 10 using the transceiver 104 and is then forwarded to the base station 20 using the transceiver 102. The user equipment 30 can receive a repeated signal transmitted from the transceiver 104 of the repeater 10. The transceiver 22 of the base station 20 is configured to transmit a signal, which is received by the repeater 10 using the transceiver 102 and is then forwarded to the user equipment 30. The base station 20 can receive a repeated signal transmitted from the transceiver 102 of the repeater 10. In this way, the user equipment 30 communicates with the base station 20 each other through the repeater 10.

Each of the processors 24 and 34 and the controller/processor 108 may be configured to implement proposed functions, procedures and/or methods described in this description. Layers of radio interface protocols may be implemented in the processors 24 and 34 and/or the controller/processor 108. The repeater 10, the base station 20 and the user equipment 30 may each include a memory operatively storing a variety of program and information to operate a connected processor. Each of the transceivers 22 and 32 and the transceivers 102 and 104 is operatively coupled with a connected processor, transmits and/or receives radio signals.

Each of the processors 24 and 34 and the controller/processor 108 may include a general-purpose central processing unit (CPU), an application-specific integrated circuits (ASICs), other chipsets, logic circuits and/or data processing devices. The memory may include a read-only memory (ROM), a random access memory (RAM), a flash memory, a memory card, a storage medium, other storage devices, and/or any combination of the memory and storage devices. Each of the transceivers 22 and 32 and the transceivers 102 and 104 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The transceivers 102 and 104 of the repeater 10 may include a donor antenna and a service antenna. The donor antenna may be mounted externally or internally at a suitable location for receiving downlink signals from the base station 20. The downlink signals are provided to the filter and amplifier 106 to be filtered and amplified based on gain control, and the resulting signals are then provided to the service antenna, which can wirelessly communicate the resulting signals to the user equipment 30. In this way, the user equipment 30 can receive stronger signals from the base station 20.

The service antenna may receive uplink signals from the user equipment 30. The uplink signals are provided to the filter and amplifier 106 to be filtered and amplified based on gain control, and the resulting signals are then provided to the donor antenna, which can wirelessly communicate the resulting signals to the base station 20. In this way, the base station 20 can receive the signals from the user equipment 30 that may be located outside of the coverage area of the base station 20.

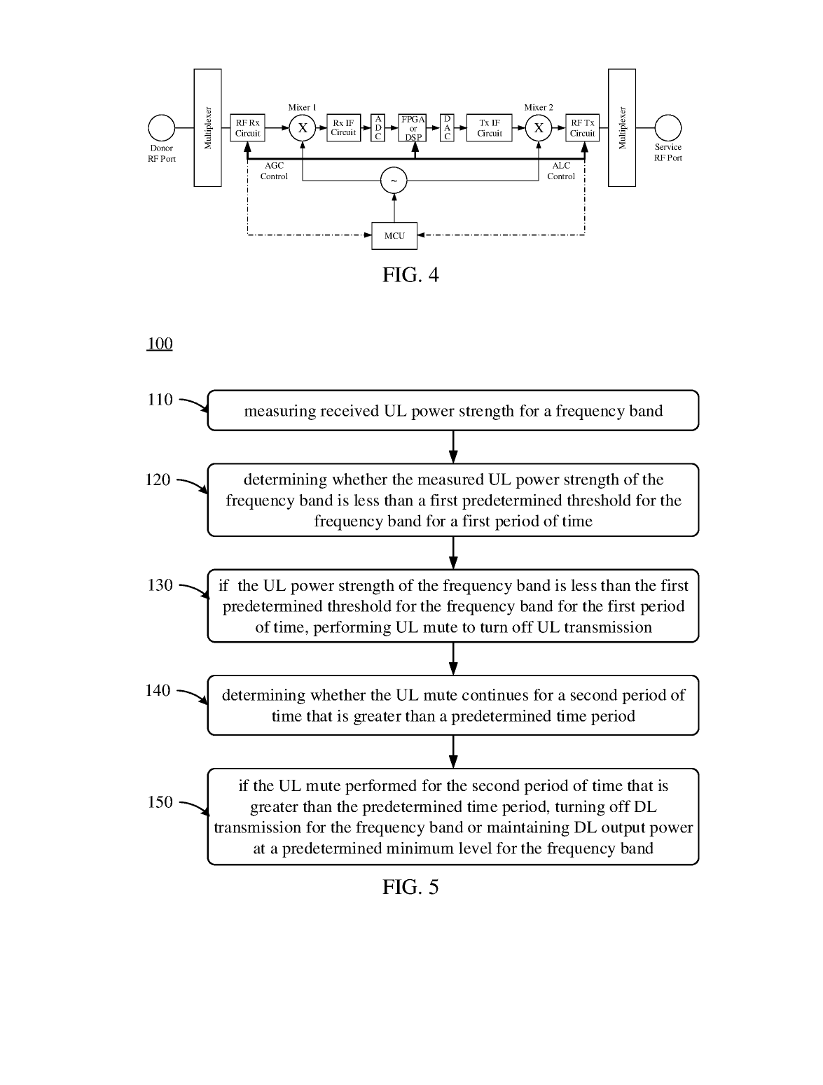

FIG. 3 illustrates an analog frequency division duplex (FDD) repeater, while FIG. 4 illustrates a digital FDD repeater. The invention can be implemented not only by the analog FDD repeater and the digital FDD repeater illustrated in FIG. 3 and FIG. 4 respectively, but also by other types of repeaters, such as an analog time division duplex (TDD) repeater, a digital TDD repeater, or a hybrid repeater with mixed analog and digital circuits. It should be noted that the repeaters shown in FIG. 3 and FIG. 4 are illustrated exemplarily in a DL configuration; however, it is straightforward to derive a UL configuration for the repeaters. As a result, the UL configuration is omitted for simplicity of description.

As shown in FIG. 3 and FIG. 4, the repeater includes a radio frequency (RF) Rx circuit, an RF Tx circuit and a microcontroller (MCU), which may correspond to the controller/processor 108 depicted in FIG. 2. In one circuit configuration, for DL signals, the RF Rx circuit may be coupled to a donor RF port (via a multiplexer) which is used to connect to a donor antenna for receiving downlink signals from the base station, and the RF Tx circuit may be coupled to a service RF port (via a multiplexer) which is used to connect to a service antenna for transmitting the downlink signals to the user equipment. In another circuit configuration, for UL signals, the RF Rx circuit may be coupled to the service antenna for receiving uplink signals from the user equipment, and the RF Tx circuit may be coupled to the donor antenna for transmitting the uplink signals to the base station. The MCU coupled to the RF Rx circuit and the RF Tx circuit is configured to control Rx Gain of the RF Rx circuit and Tx Gain of the RF Tx circuit. The total gain of the repeater is considered as a sum of Rx Gain and Tx Gain. The control of Rx Gain is achieved by AGC (Auto Gain Control), while the control of Tx Gain is by ALC (Auto Level Control). For the analog repeater depicted in FIG. 3, the Tx Gain is usually fixed and thus, the control of the total gain of the analog repeater is mainly achieved by controlling the Rx Gain by AGC. For the digital repeater depicted in FIG. 4, both the Rx Gain and the Tx gain are configurable, and thus the control of the total gain of the digital repeater is achieved by controlling the Rx Gain by AGC and controlling the Tx Gain by ALC. Synchronization of the two control loops is necessary for the digital repeater.

As depicted in FIG. 3, the analog repeater includes an intermediate frequency (IF) circuit used to generate IF signals, and two mixers (i.e., Mixer 1 and Mixer 2) for frequency mixing with carrier frequency, for example. Different from the analog repeater depicted in FIG. 3, instead of the IF circuit arranged between the two mixers, the digital repeater depicted in FIG. 4 includes a Rx IF circuit, an analog-to-digital circuit (ADC), a field programmable gate array (FPGA) or digital signal processor (DSP) chip, a digital-to-analog circuit (DAC) and a Tx IF circuit located between the two mixers. The digital repeater performs digital signal processing by using the afore-mentioned circuit elements.

The present application aims at developing an intelligent repeater (or called a cognitive repeater), which is able to sense changes during operation and then adaptively adjust operating parameters accordingly. These changes may occur in installation environment, the repeater itself, user behavior, and so on. For example, the antenna(s) of the repeater may point toward a different direction when affected by e.g., a typhon; the received signal power of the repeater may be too high due to echo interference between transmitted signals and received signals or due to self-excitation; or user activities may be low after working hours. The purpose of operating parameter adjustment is to optimize the overall performance, lower the power consumption and/or elongate the life cycle of the cognitive repeater.

The present application provides various power saving schemes for the repeater. In one embodiment, in order to further reduce power consumption of the repeater, DL transmission in a specific band is turned off when UL mute continues for a certain period of time. In another embodiment, DL transmission in a specific band is turned off due to a large difference between DL power strength for the frequency band and an averaged DL power strength for other frequency bands.

FIG. 5 is a flowchart of a power saving method 100 according to a first embodiment of the present application. The power saving method 100 is applied to a repeater, which is used to amplify cellular communication signals (which may be communicated between a base station and a user equipment in a network). The exemplary structure of the repeater may be referred to FIGS. 2 to 4. The power saving method 100 may be implemented in the MCU depicted in FIGS. 3 and 4 or any additional processing unit in the repeater. The method 100 includes the following steps.

In Step 110, the repeater measures received uplink (UL) power strength (e.g., UL RSSI) for a frequency band. The frequency band is one of frequency bands supported by the repeater and is an active frequency band used between the user equipment and the base station. This method 100 can be performed for each of available frequency bands and achieve power saving for individual frequency bands.

In Step 120, the repeater determines whether the measured UL power strength of the frequency band is less than a first predetermined threshold (e.g., a UL mute threshold) for the frequency band for a first period of time (e.g., ten minutes). In Step 130, if the UL power strength of the frequency band is less than the first predetermined threshold for the frequency band for the first period of time, the repeater performs UL mute to turn off UL transmission. That is, the first predetermined threshold and the first period of time are criteria for the repeater to determine whether to perform the UL mute. When the UL mute is performed, the repeater may turn off the UL transmission by controlling the power amplifier (PA) to set UL output power to be zero or by prohibiting the antenna from transmitting UL signals. The UL mute may not be performed if the UL power strength of the frequency band is greater than the first predetermined threshold for the frequency band.

In Step 140, the repeater determines whether the UL mute continues for a second period of time that is greater than a predetermined time period (e.g., one hour). In Step 150, if the UL mute is performed for the second period of time that is greater than the predetermined time period, the repeater turns off downlink (DL) transmission for the frequency band. That is, the first predetermined threshold and the predetermined time period are criteria for the repeater to determine whether to turn off the DL transmission for the frequency band. The repeater may turn off the DL transmission by controlling the power amplifier (PA) to set DL output power to be zero or by prohibiting the antenna from transmitting DL signals. If the UL mute does not continue for the predetermined time period, that is, the UL mute is stopped during the predetermined time period, the repeater may not turn off the DL transmission for the frequency band. It should be noted that instead of turning off the DL transmission, the repeater may maintain DL output power at a predetermined minimum level for the frequency band such that the repeater can still maintain a small coverage for downlink signals (e.g., broadcast signals or synchronization signals from the base station) while the overall power consumption is reduced.

The present application provides the power saving method 100 as described above. In this power saving method 100, the repeater turns off the DL transmission for the frequency band or maintain DL output power at a predetermined minimum level for the frequency band when the UL mute is performed for a period of time that is greater than the predetermined time period. That is, the DL transmission in a given frequency band is turned off when UL mute continues for the predetermined time period. Since the DL transmission is also turned off, this can reduce the power consumption of the repeater to a great extent, as compared to the case where only UL mute is performed in the existing arts.

For example, for a repeater installed on an office building, after working hours or at midnight, user activities are quite low. It does not need the repeater to amplify communication signals between the base station and the user equipment anymore. In addition to the UL mute, if the DL transmission can be turned off, the repeater can save most of its power. If it is detected that the UL mute continues for the predetermined time period, it can be determined that there would be no user activities and there is no need to forward any signals by the repeater. Therefore, the repeater can turn off the DL transmission in addition to the UL mute.

In one embodiment, the DL transmission for a given frequency band can be turned off right away (i.e., one-shot off). In another embodiment, the DL output power for a given frequency band can be reduced gradually (i.e., continuous off). When the DL output power is reduced to zero, the DL transmission is completely turned off. Likewise, the DL output power may maintain at the predetermined minimum level in one adjustment or several times of adjustment.

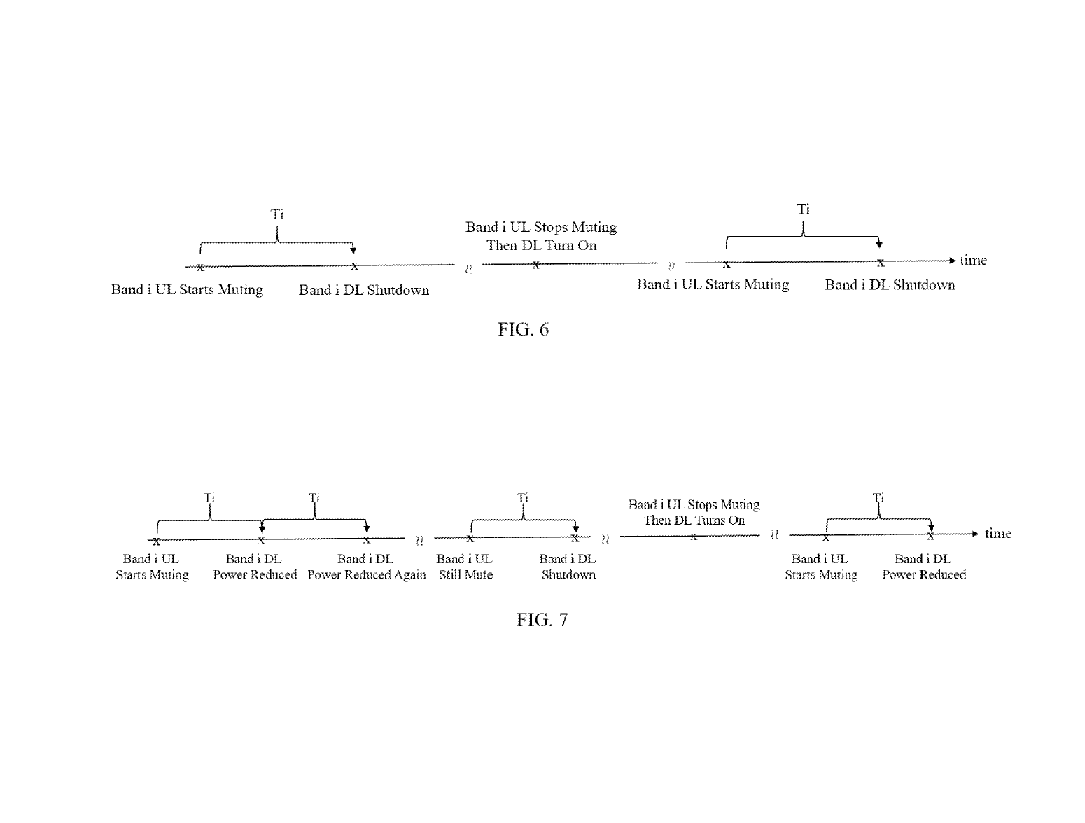

FIG. 6 is a schematic diagram illustrating one-shot off to turn off DL transmission right away according to some embodiments of the present application. Referring to FIG. 6, Ti stands for a predetermined time period for Band i. For a given Band i, when the UL mute persists for a time duration equal to the predetermined time period Ti, the DL transmission for Band i is turned off immediately (i.e., one-shot off). The UL mute may stop periodically, or the UL transmission may be re-enabled if any UE activity is detected or if triggered by some events. Once the UL mute is performed again, the DL transmission will be turned off again and again if the period of time the UL mute continues is longer than or equal to the predetermined time period Ti.

FIG. 7 is a schematic diagram illustrating continuous off to gradually reduce DL output power until shutdown according to some embodiments of the present application. As compared to the one-shot off illustrated in FIG. 6, referring to FIG. 7, the DL output power for a given Band i is reduced gradually (i.e., continuous off). There may have several times to reduce the DL output power. For each time, the DL output power may be reduced by a same amount of power. The DL transmission is completely turned off when the DL output power is finally reduced to zero.

In some embodiments, a certain amount of power applied to reduce the DL output power is variable whenever the DL output power needs to be reduced. That is, the DL output power may be reduced by a first amount of power in current adjustment and may be reduced by a second amount of power in next adjustment. When the first amount of power is greater than the second amount of power, that is, the DL output power to be reduced decreases progressively, the DL coverage of the repeater will be reduced in a relatively slow speed. When the second amount of power is greater than the first amount of power, that is, the DL output power to be reduced increases progressively, the DL coverage of the repeater will be reduced in a relatively quick speed.

In some embodiments, the predetermined time period is variable whenever the repeater needs to determine whether the UL mute continues for the period of time that is greater than the predetermined time period. For example, a first predetermined time period used in current adjustment of the DL output power may be longer or shorter than a second predetermined time period used in next adjustment. When the first predetermined time period is shorter than the second predetermined time period, i.e., the predetermined time period increases progressively, the DL coverage of the repeater will be reduced in a relatively slow speed. When the first predetermined time period is longer than the second predetermined time period, i.e., the predetermined time period decreases progressively, the DL coverage of the repeater will be reduced in a relatively quick speed.

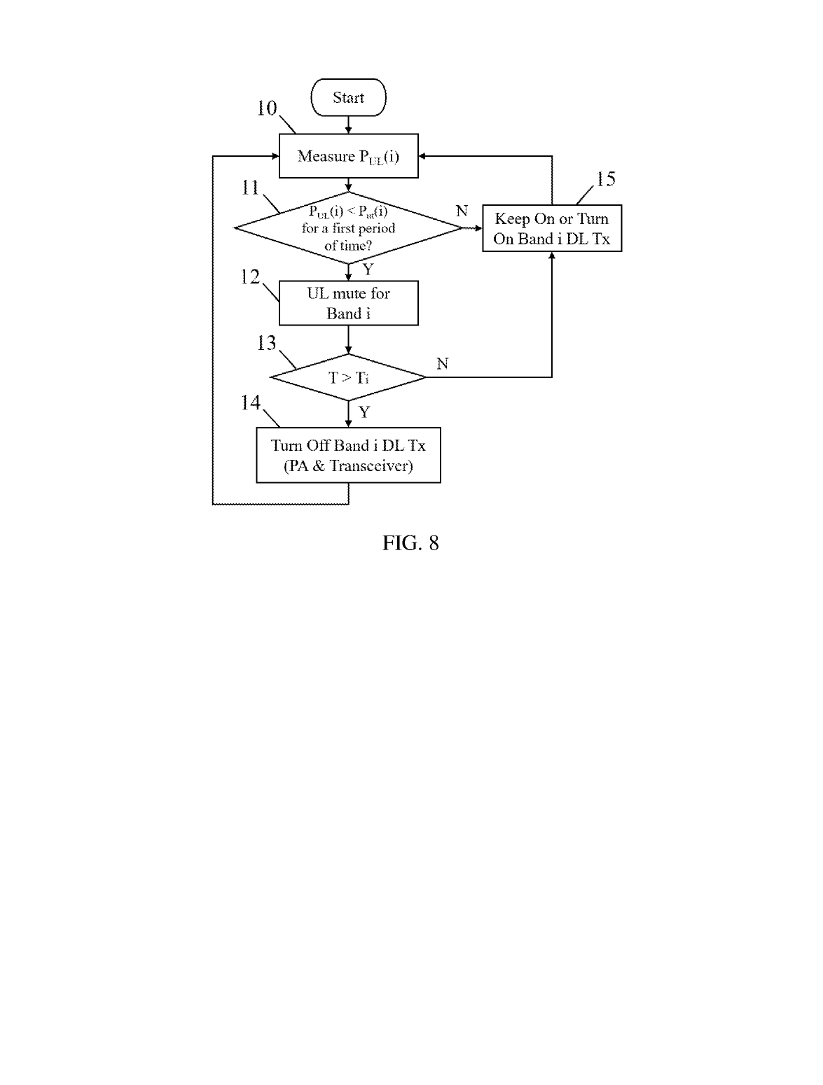

FIG. 8 is a flow chart of a first example of power saving scheme according to some embodiments of the present application. This is an example of one-shot off to turn off DL transmission right away. Referring to FIG. 8, the repeater measures received UL power strength (e.g., UL RSSI) P_{UL}(i) for a given Band i in Step 10. Then, in Step 11, for Band i, the repeater determines whether the measured P_{UL}(i) is less than a predetermined threshold (e.g., UL mute threshold) Pᵤₜ(i) for a first period of time. In Step 12, the UL mute is performed if P_{UL}(i) < Pᵤₜ(i) for the first period of time. Then, the repeater checks whether the UL mute continues for a second period of time T that is greater than a predetermined time period Ti in Step 13. A timer may be used in this step. In Step 14, if T > Ti, the repeater turns off DL transmission for Band i right away or in one-shot. This may be done by controlling a power amplifier (PA) to adjust DL output power to zero or by prohibiting the antenna from transmitting DL signals. If the repeater determines that P_{UL}(i) ≥ Pᵤₜ(i) in Step 11 or if T ≤ Ti in Step 13, the repeater may turn on the DL transmission for Band i when the DL transmission is in an off state or keep the DL transmission on for Band i when the DL transmission is already in an on state, as shown in Step 15. Other available frequency bands are checked using the procedures similar to Band i.

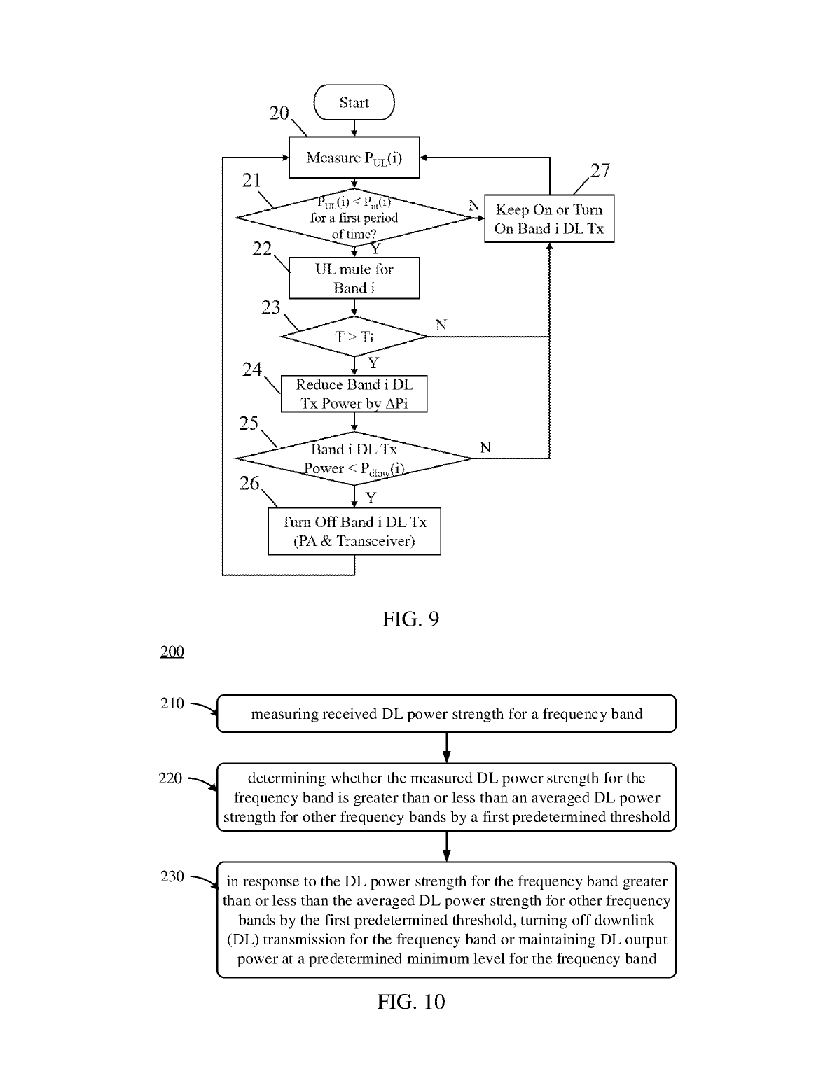

FIG. 9 is a flow chart of a second example of power saving scheme according to some embodiments of the present application. This is an example of continuous off to gradually reduce DL output power until shutdown. Referring to FIG. 9, the repeater measures received UL power strength (e.g., UL RSSI) P_{UL}(i) for a given Band i in Step 20. Then, in Step 21, for Band i, the repeater determines whether the measured P_{UL}(i) is less than a predetermined threshold (e.g., UL mute threshold) Pᵤₜ(i) for a first period of time. In Step 22, the UL mute is performed if P_{UL}(i) < Pᵤₜ(i) for the first period of time. Then, the repeater checks whether the UL mute continues for a second period of time T that is greater than a predetermined time period Ti in Step 23. In Step 24, if T > Ti, the repeater reduces the DL output power by a certain amount of power ΔPi. The repeater may reduce the DL output power by ΔPi each time the second period of time, during which the UL mute is performed, is determined to be greater than the predetermined time period Ti. In Step 25, the repeater determines whether the DL output power is reduced to a power level less than a predetermined threshold (e.g., DL Tx turn-off threshold) P_{dlow}(i) for Band i. If the DL output power is reduced to a power level less than P_{dlow}(i), the repeater turns off DL transmission for Band i in Step 26. If the repeater determines that P_{UL}(i) ≥ Pᵤₜ(i) in Step 21 or if T ≤ Ti in Step 23 or if Band i DL Tx Power ≥ P_{dlow}(i) in Step 25, the repeater may turn on the DL transmission for Band i when the DL transmission is in an off state or keep the DL transmission on for Band i when the DL transmission is already in an on state, as shown in Step 27. Other available frequency bands are checked using the procedures similar to Band i.

FIG. 10 is a flowchart of a power saving method 200 according to a second embodiment of the present application. The power saving method 200 is applied to a repeater, which is used to amplify cellular communication signals (which may be communicated between a base station and a user equipment in a network). The exemplary structure of the repeater may be referred to FIGS. 2 to 4. The power saving method 200 may be implemented in the MCU depicted in FIGS. 3 and 4 or any additional processing unit in the repeater. The method 200 includes the following steps.

In Step 210, the repeater measures received downlink (DL) power strength (e.g., DL RSSI) for a frequency band. The frequency band is one of frequency bands supported by the repeater and is an active frequency band used between the user equipment and the base station. This method 200 can be performed for each of available frequency bands and achieve power saving for individual frequency bands.

In Step 220, the repeater determines whether the measured DL power strength for the frequency band is greater than or less than an averaged DL power strength for other frequency bands by a first predetermined threshold or exceeds a predetermined range with respect to the averaged DL power strength for other frequency bands. Specifically, the repeater may determine whether an absolute value of a difference between the DL power strength for the frequency band and the averaged DL power strength for other frequency bands is greater than the first predetermined threshold.

In Step 230, if the DL power strength of the frequency band is greater than or less than the averaged DL power strength for other frequency bands by the first predetermined threshold, the repeater turns off the DL transmission for the frequency band. That is, the first predetermined threshold is a criterion for the repeater to determine whether to turn off the DL transmission for the frequency band. The repeater may turn off the DL transmission by controlling the power amplifier (PA) to set DL output power to be zero or by prohibiting the antenna from transmitting DL signals. If the DL power strength of the frequency band is not greater than or less than the averaged DL power strength for other frequency bands by the first predetermined threshold, the repeater may not turn off the DL transmission for the frequency band. It should be noted that instead of turning off the DL transmission, the repeater may maintain DL output power at a predetermined minimum level for the frequency band such that the repeater can still maintain a small coverage for downlink signals (e.g., broadcast signals or synchronization signals from the base station) while the overall power consumption is reduced.

The present application provides the power saving method 200 as described above. In this power saving method 200, the repeater turns off the DL transmission for the frequency band or maintain DL output power at a predetermined minimum level for the frequency band when the DL power strength of the frequency band is greater than or less than the averaged DL power strength for other frequency bands by the first predetermined threshold. That is, the DL transmission in a given band is turned off due to a large difference between DL power strength for the frequency band and an averaged DL power strength for other frequency bands. This can reduce the power consumption of the repeater since the DL transmission is turned off.

When the DL power strength of a frequency band is much higher than the other frequency bands, say 20dB higher, the repeater turns off the DL transmission for the frequency band since DL signals of the frequency band with high power strength would not need forwarding. When the DL power strength of a frequency band is much lower than the other frequency bands, say 20dB lower, the repeater turns off the DL transmission for the frequency band since the received signal quality would be too poor to be worth forwarding.

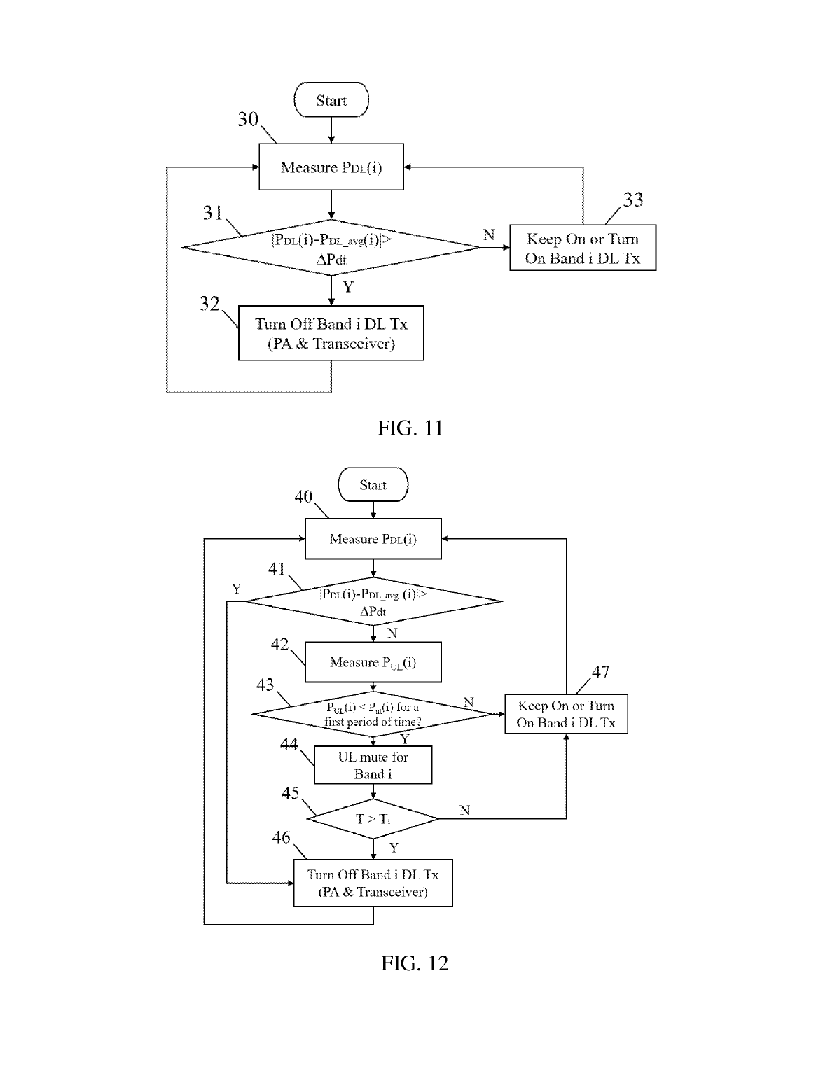

FIG. 11 is a flow chart of a third example of power saving scheme according to some embodiments of the present application. This is an example of power saving scheme for inappropriate DL power strength. Referring to FIG. 11, the repeater measures received DL power strength (e.g., DL RSSI) P_{DL}(i) for a given Band i in Step 30. Then, in Step 31, for Band i, the repeater determines whether an absolute value |P_{DL}(i)-P_{DL_avg}(i)| of a difference between P_{DL}(i) and an averaged DL power strength P_{DL_avg}(i) for other frequency bands is greater than a predetermined threshold (e.g., DL power difference threshold) ΔPdt. In Step 32, if |P_{DL}(i)-P_{DL_avg}(i)| > ΔPdt, the repeater turns off DL transmission for Band i. This may be done by controlling a power amplifier (PA) to adjust DL output power to zero or by prohibiting the antenna from transmitting DL signals. If the repeater determines that |P_{DL}(i)-P_{DL_avg}(i)| ≤ ΔPdt in Step 31, the repeater may turn on the DL transmission for Band i when the DL transmission is in an off state or keep the DL transmission on for Band i when the DL transmission is already in an on state, as shown in Step 33. Other available frequency bands are checked using the procedures similar to Band i.

FIG. 12 is a flow chart of a fourth example of power saving scheme according to some embodiments of the present application. This is an example of a combination of inappropriate DL power strength and one-shot off. Referring to FIG. 12, the repeater measures received DL power strength (e.g., DL RSSI) P_{DL}(i) for a given Band i in Step 40. Then, in Step 41, for Band i, the repeater determines whether an absolute value |P_{DL}(i)-P_{DL_avg}(i)| of a difference between P_{DL}(i) and an averaged DL power strength P_{DL_avg}(i) for other frequency bands is greater than a predetermined threshold (e.g., DL power difference threshold) ΔPdt. In Step 46, if |P_{DL}(i)-P_{DL_avg}(i)| > ΔPdt, the repeater turns off DL transmission for Band i. If the repeater determines that |P_{DL}(i)-P_{DL_avg}(i)| ≤ ΔPdt in Step 41, the repeater may continue to measure received UL power strength (e.g., UL RSSI) P_{UL}(i) for Band i in Step 42. Then, in Step 43, for Band i, the repeater determines whether the measured P_{UL}(i) is less than a predetermined threshold (e.g., UL mute threshold) Pᵤₜ(i) for a first period of time. In Step 44, the UL mute is performed if P_{UL}(i) < Pᵤₜ(i) for the first period of time. Then, the repeater checks whether the UL mute continues for a second period of time T that is greater than a predetermined time period Ti in Step 45. In Step 46, if T > Ti, the repeater turns off DL transmission for Band i right away or in one-shot. If the repeater determines that P_{UL}(i) ≥ Pᵤₜ(i) in Step 43 or if T ≤ Ti in Step 45, the repeater may turn on the DL transmission for Band i when the DL transmission is in an off state or keep the DL transmission on for Band i when the DL transmission is already in an on state, as shown in Step 47. Other available frequency bands are checked using the procedures similar to Band i.

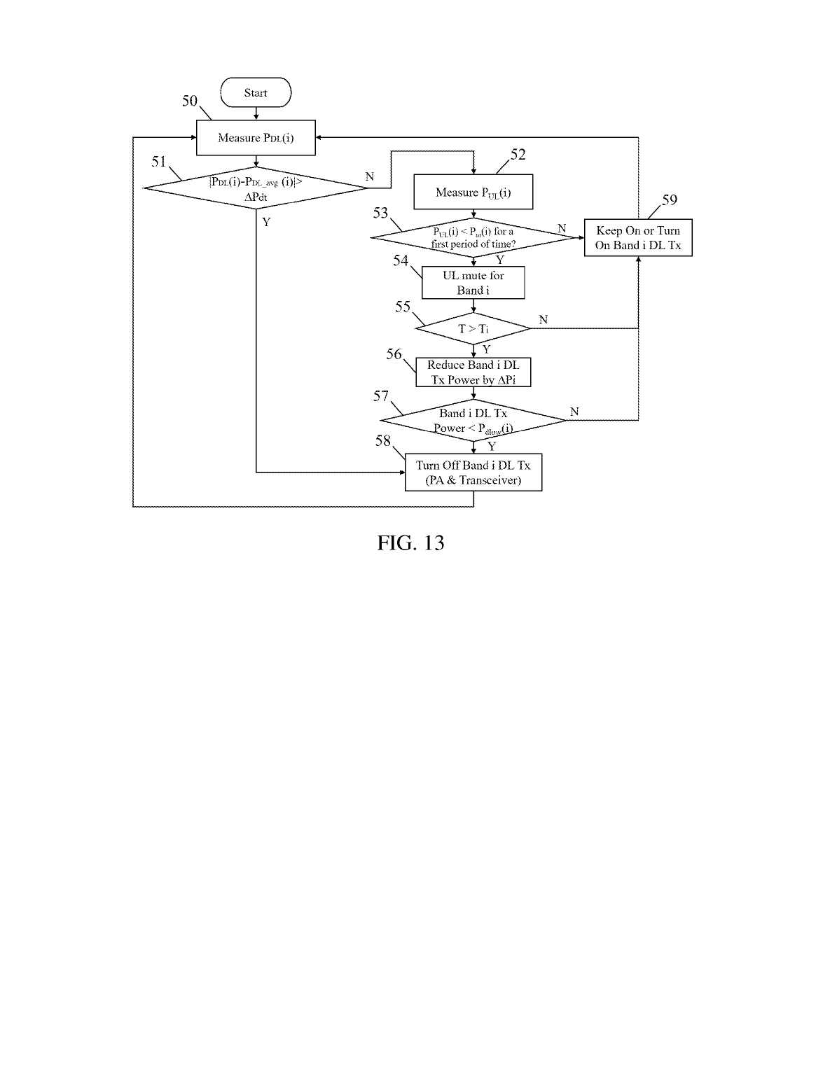

FIG. 13 is a flow chart of a fifth example of power saving scheme according to some embodiments of the present application. This is an example of a combination of inappropriate DL power strength and continuous off. Referring to FIG. 13, the repeater measures received DL power strength (e.g., DL RSSI) P_{DL}(i) for a given Band i in Step 50. Then, in Step 51, for Band i, the repeater determines whether an absolute value |P_{DL}(i)-P_{DL_avg}(i)| of a difference between P_{DL}(i) and an averaged DL power strength P_{DL_avg}(i) for other frequency bands is greater than a predetermined threshold (e.g., DL power difference threshold) ΔPdt. In Step 58, if |P_{DL}(i)-P_{DL_avg}(i)| > ΔPdt, the repeater turns off DL transmission for Band i. If the repeater determines that |P_{DL}(i)-P_{DL_avg}(i)| ≤ ΔPdt in Step 51, the repeater may continue to measure received UL power strength (e.g., UL RSSI) P_{UL}(i) for Band i in Step 52. Then, in Step 53, for Band i, the repeater determines whether the measured P_{UL}(i) is less than a predetermined threshold (e.g., UL mute threshold) Pᵤₜ(i) for a first period of time. In Step 54, the UL mute is performed if P_{UL}(i) < Pᵤₜ(i) for the first of time. Then, the repeater checks whether the UL mute continues for a second period of time T that is greater than a predetermined time period Ti in Step 55. In Step 56, if T > Ti, the repeater reduces the DL output power by a certain amount of power ΔPi. The repeater may reduce the DL output power by ΔPi each time the second period of time, during which the UL mute is performed, is determined to be greater than the predetermined time period Ti. In Step 57, the repeater determines whether the DL output power is reduced to a power level less than a predetermined threshold (e.g., DL Tx turn-off threshold) P_{dlow}(i) for Band i. If the DL output power is reduced to a power level less than P_{dlow}(i), the repeater turns off DL transmission for Band i in Step 58. If the repeater determines that P_{UL}(i) ≥ Pᵤₜ(i) in Step 53 or if T ≤ Ti in Step 55 or if Band i DL Tx Power ≥ P_{dlow}(i) in Step 57, the repeater may turn on the DL transmission for Band i when the DL transmission is in an off state or keep the DL transmission on for Band i when the DL transmission is already in an on state, as shown in Step 59. Other available frequency bands are checked using the procedures similar to Band i.

The embodiment of the present application further provides a repeater, which may be used to amplify cellular communication signals between a base station and a user equipment. The repeater includes a Rx circuit; a Tx circuit; and at least one processor, coupled to the Rx circuit and the Tx circuit, the at least one processor being configured to execute corresponding processes implemented in each of the methods of the embodiments of the present application. For brevity, details will not be described herein again.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A power saving method by a repeater, comprising:
measuring received uplink (UL) power strength for a frequency band;
determining whether the measured UL power strength of the frequency band is less than a first predetermined threshold for the frequency band for a first period of time;
in response to the UL power strength of the frequency band less than the first predetermined threshold for the frequency band for the first period of time, performing UL mute to turn off UL transmission;
determining whether the UL mute continues for a second period of time that is greater than a predetermined time period; and
in response to the UL mute performed for the second period of time that is greater than the predetermined time period, turning off downlink (DL) transmission for the frequency band or maintaining DL output power at a predetermined minimum level for the frequency band.

2. The method according to claim 1, further comprising:
keeping on or turning on the DL transmission for the frequency band in response to the UL power strength of the frequency band greater than the first predetermined threshold for the frequency band.

3. The method according to claim 1, further comprising:
keeping on or turning on the DL transmission for the frequency band in response to the UL mute performed for the second period of time that is less than the predetermined time period.

4. The method according to claim 1, wherein before turning off the DL transmission for the frequency band or maintaining the DL output power at the predetermined minimum level for the frequency band, the method further comprises:
reducing the DL output power by a certain amount of power each time the second period of time, during which the UL mute is performed, is determined to be greater than the predetermined time period.

5. The method according to claim 4, further comprising:
determining whether the DL output power is reduced to a power level less than a second predetermined threshold; and
in response to the DL output power reduced to the power level less than the second predetermined threshold, turning off the DL transmission for the frequency band or maintaining the DL output power at the predetermined minimum level for the frequency band.

6. The method according to claim 4, wherein the certain amount of power applied to reduce the DL output power is variable whenever the DL output power needs to be reduced.

7. The method according to claim 4, wherein the predetermined time period is variable whenever the repeater needs to determine whether the UL mute continues for the second period of time that is greater than the predetermined time period.

8. The method according to claim 1, further comprising:
measuring received DL power strength for the frequency band;
determining whether the measured DL power strength for the frequency band is greater than or less than an averaged DL power strength for other frequency bands by a third predetermined threshold;
in response to the DL power strength for the frequency band greater than or less than the averaged DL power strength for other frequency bands by the third predetermined threshold, turning off the DL transmission for the frequency band or maintaining the DL output power at the predetermined minimum level for the frequency band; and
in response to the DL power strength for the frequency band not greater than or less than the averaged DL power strength for other frequency bands by the third predetermined threshold, keeping on or turning on the DL transmission for the frequency band.

9. The method according to claim 8, wherein the determining whether the DL power strength for the frequency band is greater than or less than the averaged DL power strength for other frequency bands by the third predetermined threshold comprises:
determining whether an absolute value of a difference between the DL power strength for the frequency band and the averaged DL power strength for other frequency bands is greater than the third predetermined threshold.

10. A repeater, comprising:
a Rx circuit;
a Tx circuit; and
at least one processor, coupled to the Rx circuit and the Tx circuit, the at least one processor being configured to execute the method according to claim 1.

11. A power saving method by a repeater, comprising:
measuring received downlink (DL) power strength for a frequency band;
determining whether the measured DL power strength for the frequency band is greater than or less than an averaged DL power strength for other frequency bands by a first predetermined threshold; and
in response to the DL power strength for the frequency band greater than or less than the averaged DL power strength for other frequency bands by the first predetermined threshold, turning off DL transmission for the frequency band or maintaining DL output power at a predetermined minimum level for the frequency band.

12. The method according to claim 11, wherein the determining whether the DL power strength for the frequency band is greater than or less than the averaged DL power strength for other frequency bands by the first predetermined threshold comprises:
determining whether an absolute value of a difference between the DL power strength for the frequency band and the averaged DL power strength for other frequency bands is greater than the first predetermined threshold.

13. The method according to claim 11, further comprising:
measuring received uplink (UL) power strength for the frequency band;
determining whether the measured UL power strength of the frequency band is less than a second predetermined threshold for the frequency band for a first period of time;
in response to the UL power strength of the frequency band less than the second predetermined threshold for the frequency band for the first period of time, performing UL mute to turn off UL transmission;
determining whether the UL mute continues for a second period of time that is greater than a predetermined time period; and
in response to the UL mute performed for the second period of time that is greater than the predetermined time period, turning off the DL transmission for the frequency band or maintaining the DL output power at the predetermined minimum level for the frequency band.

14. The method according to claim 13, further comprising:
keeping on or turning on the DL transmission for the frequency band in response to the UL power strength of the frequency band greater than the second predetermined threshold for the frequency band.

15. The method according to claim 13, further comprising:
keeping on or turning on the DL transmission for the frequency band in response to the UL mute performed for the second period of time that is less than the predetermined time period.

16. The method according to claim 13, wherein before turning off the DL transmission for the frequency band or maintaining the DL output power at the predetermined minimum level for the frequency band, the method further comprises:
reducing the DL output power by a certain amount of power each time the second period of time, during which the UL mute is performed, is determined to be greater than the predetermined time period.

17. The method according to claim 16, further comprising:
determining whether the DL output power is reduced to a power level less than a third predetermined threshold; and
in response to the DL output power reduced to the power level less than the third predetermined threshold, turning off the DL transmission for the frequency band or maintaining the DL output power at the predetermined minimum level for the frequency band.

18. The method according to claim 16, wherein the certain amount of power applied to reduce the DL output power is variable whenever the DL output power needs to be reduced.

19. The method according to claim 16, wherein the predetermined time period is variable whenever the repeater needs to determine whether the UL mute continues for the second period of time that is greater than the predetermined time period.

20. A repeater, comprising:
a Rx circuit;
a Tx circuit; and
at least one processor, coupled to the Rx circuit and the Tx circuit, the at least one processor being configured to execute the method according to claim 11.
